(19) United States
(12) Patent Application Publication
(10) Pub. No.: US 2009/0326507 A1
(43) Pub. Date: Dec. 31, 2009

(54) Small container

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 12/215,590

(22) Filed: Jun. 26, 2008

(51) Int. Cl. A61J 1/14

(52) U.S. Cl. 604/415

(57) ABSTRACT

A small slender container that may be used to store and dispense small quantity of fluid, such as eye medications, in a sealed environment. The slender container is a small diameter squeezable slender container with channels or raised ribs on the inside surface of the slender container extending from one end of the slender container to the other end. An opening means is provided near one end of the slender container to release the enclosed fluid. Virtually all of the enclosed fluid will be extracted from the container with no fluid remaining in the container.

### BACKGROUND

1. Field of the Invention

The present invention relates to a small sealed container. More specifically, the present invention relates to a small sealed container that may be used to store and dispense small amount of fluids such as eye medications.

2. Description of Related Art

Small containers in the general form of an eye dropper are generally used to distribute and apply drops of eye medications. Such containers are usually made as small as possible because the eye medications are expensive and only a very small amount is necessary. However, due to the surface tension of the eye medications, there is a limitation to how small of a diameter of the container may be used and still allow the eye medications to be dispensed from the container.

If the diameter of the container is too small, the eye medications cannot be dispensed from the container due to the surface tension of the fluid. If the diameter of the container is large, the eye medications in the container can be easily dispensed. However, since the eye medications are expensive and only a few drops is necessary per use, a large diameter container is not economical or practical. Furthermore, a larger multi-use container will require preservatives for the eye medication or risk contamination. Preservatives are not desirable in eye medications and may irritate the eyes.

There is a point where the diameter of the container is made as small as possible and yet still allows the eye medications in the container to be dispensed with ease. Most single-dose eye medications containers are made with diameters at this minimum diameter. However, even at this minimum diameter, the eye medications container is still too large and not economical for dispensing drops of eye medications. Much more eye medications than necessary for a single use must still be filled in this minimal sized container or the container will have a large void that appears to be left from evaporated eye medications.

Although a smaller diameter container is desirable, it has not been possible due to the physical phenomenon of surface tension of the eye medications that limits how small a diameter the container may have. The present invention is a simple yet effective means to allow a very small diameter container to be used for dispensing drops of eye medications efficiently and economically.

### BRIEF SUMMARY OF THE INVENTION

The present invention is a small slender container that may be used to store small quantity of fluid, such as eye medications, in a sealed environment and easily dispenses the fluid as desired. The content of the slender container is completely sealed and will not leak or evaporate from the container. The slender container is a small diameter squeezable slender container with channels or raised ribs on the inside surface of the slender container extending from one end of the slender container to the other end. An opening means is provided near one end of the slender container to release the enclosed fluid. Virtually all of the enclosed fluid will be extracted from the container with no fluid remaining in the container.

### BRIEF DESCRIPTION OF THE DRAWINGS

FIG. 1 shows a cross-sectional view of the preferred embodiment of the small container.

FIG. 2 shows another cross-sectional view of the preferred embodiment of the small container shown in FIG. 1.

FIG. 3 shows a cross-sectional view of another embodiment of the small container.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

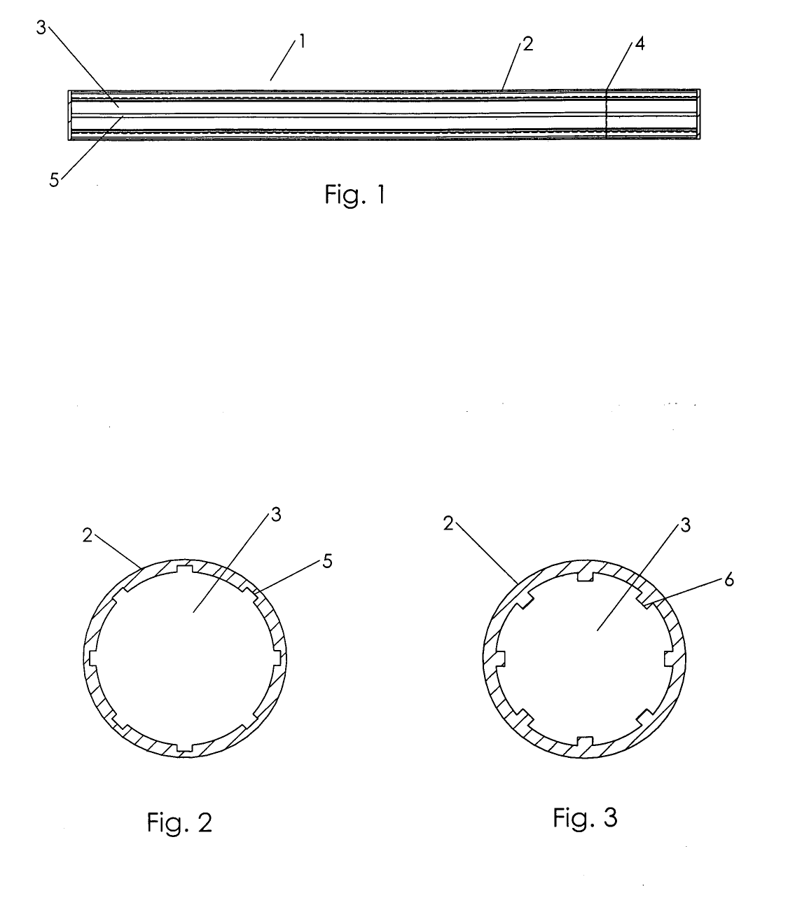

FIGS. 1 and 2 show the preferred embodiment of the small container 1. The small container 1 has a squeezable elongated housing 2 with two ends that are sealed and encloses a fluid 3. On the inside surface of the walls of the elongated housing 2 are small channels 5 oriented parallel to the length of the elongated housing 2. The channels 5 extend from one end of the elongated housing 2 to the other end of the elongated housing 2. An opening means 4 in the form of a score on the elongated housing 2 is located near a sealed end of the elongated housing 2. The opening means 4 may alternatively be a frangible section, a thin walled section, a twist off cap, or other similar means.

The fluid 3 is sealed within the elongated housing 2 until released through the opening means 4. When the small container 1 is opened by the opening means 4, inverted so that the opened end is directed downward whereby the fluid 3 moves towards the opening, and squeezed, the fluid 3 in the elongated housing 2 will be released from the elongated housing 2 in controlled drop forms. The channels 5 in the elongated housing 2 enable the fluid 3 in the elongated housing 2 to move freely from one end of the elongated housing 2 to the other end. Virtually all of the enclosed fluid 3 in the elongated housing 2 will be extracted from the elongated housing 2 after just a few squeezes of the elongated housing 2.

FIG. 3 shows another embodiment of the small container 1 wherein, instead of channels 5 on the inside surface of the walls of the elongated housing 2, raised ribs 6 extend along the length of the elongated housing 2.

Alternatively, channels 5 and raised ribs 6 may both be present on the inside surface of the walls of the elongated housing 2 either in alternating positions or in any combination thereof.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A small container comprising a sealed elongated housing with one or more channels extending along its length on an inside wall of said elongated housing and with an opening means near an end of said elongated housing whereby said elongated housing encloses a fluid.

2. A small container as in claim 1, wherein said elongated housing is squeezable.

3. A small container as in claim 1, wherein the opening means is a scoring, a frangible section, or a thin section that can be broken open to release the fluid in said elongated housing.

4. A small container comprising a sealed elongated housing with one or more raised ribs extending along its length on an inside wall of said elongated housing and with an opening means near an end of said elongated housing whereby said elongated housing encloses a fluid.

5. A small container as in claim 4, wherein said elongated housing is squeezable.

6. A small container as in claim 4, wherein the opening means is a scoring, a frangible section, or a thin section that can be broken open to release the fluid in said elongated housing.
